(19) United States
(12) Patent Application Publication
(10) Pub. No.: US 2020/0349789 A1
(43) Pub. Date: Nov. 5, 2020

(54) MOBILE ROBOT MANAGEMENT SERVICE SYSTEM

(71) Applicant: LG ELECTRONICS INC., Seoul (KR)

(72) Inventors: Sunryang KIM, Seoul (KR); Yoonsik KIM, Seoul (KR); Keunsik NO, Seoul (KR); Hyeri PARK, Seoul (KR); Woojin JEONG, Seoul (KR)

(73) Assignee: LG ELECTRONICS INC., Seoul (KR)

(21) Appl. No.: 16/963,077

(22) PCT Filed: Aug. 1, 2019
(86) PCT No.: PCT/KR2019/009640

§ 371 Date: Jul. 17, 2020

(30) Foreign Application Priority Data
Nov. 9, 2018 (KR) 10-2018-0137640

(51) Int. Cl. G07C 9/28; H04W 12/00

(52) U.S. Cl. CPC G07C 9/28; H04W 12/002

(57) ABSTRACT

Disclosed is a mobile robot management service system. The mobile robot management service system can assist in automatic charging of a user terminal module through a detachable holding structure of the user terminal module and a mobile robot, can secure private data of a user requesting use of the mobile robot through a mobile communication device, and allows only a user obtaining use approval to use the user terminal module and the mobile robot, thereby improving reliability by preventing theft and loss of the mobile robot and the user terminal module.

### TECHNICAL FIELD

The present disclosure relates to a mobile robot management service system capable of operating in association with a user terminal module and accessories including a mobile communication device.

### BACKGROUND ART

As a part of factory automation, robots have been developed for industrial use. In recent years, application of robots has been further expanded to develop robots that can be used in daily life, as well as medical robots and aerospace robots.

Recently, there is a need for robots that can provide various services. Such robots for daily life provide specific services, for example, shopping, transporting, serving, talking, cleaning, and the like, in response to a user command.

By way of example, Korean Patent Laid-open Publication No. 2010-98056 discloses a cart robot driving system. The cart robot is moved by pushing or dragging with a user hand, and generally includes a basket adapted to receive goods therein, a liftable plate disposed on an inner bottom of the basket to allow the goods to be placed thereon, and a lifting unit lifting or lowering the plate to lift or lower the goods placed on the plate inside the basket.

As disclosed in the above publication, typical robots for daily life are developed to provide specific services. However, despite the structure of the robots adapted to perform only limited functions, such robots have a problem of low utilization, considering costs for development of the robots.

Moreover, since theft or loss of cart robots developed and commercialized through extensive investment causes significant damage to developers or owners of the robots, it is necessary to exert a great deal of effort to prevent theft or loss of the cart robots. Therefore, there is a need for construction of a system for preventing theft or loss of the cart robots corresponding to environments or situations in which the cart robots are used.

### DISCLOSURE

### Technical Problem

Embodiments of the present disclosure provide a mobile robot management service system that can secure private data of a user requesting use of a mobile robot through a mobile communication device and the like and allows only a user obtaining use approval to use a user terminal module and the mobile robot, thereby preventing theft and loss of the mobile robot.

Embodiments of the present disclosure provide a mobile robot management service system that can assist in automatic charging of a user terminal module through a detachable holding structure of the user terminal module and a mobile robot and allows the mobile robot to drive along a movement course of the user terminal module or assists in driving of the mobile robot to allow the mobile robot to be used as a shopping cart.

Embodiments of the present disclosure provide a mobile robot management service system that allows a distance between a user carrying a user terminal module and a mobile robot to be automatically detected in real time and allows the user terminal module and the mobile robot to operate simultaneously in an antitheft mode based on a detection result.

Objectives of the present disclosure are not limited to what has been described. Additionally, other objectives and advantages that have not been mentioned may be clearly understood from the following description and may be more clearly understood from embodiments. Further, it will be understood that the objectives and advantages of the present disclosure may be realized via means and a combination thereof that are described in the appended claims.

### Technical Solution

In accordance with one embodiment of the present disclosure, a mobile robot is set to a standby mode to charge a terminal module in a state in which the terminal module is mounted thereon, and detects a location of the terminal module and a distance from the mobile robot to the terminal module in real time to assist in driving after being automatically set to or converted into one mode selected from among a user tracking mode, a standby mode, and a drive power assistance mode, when the terminal module is detached therefrom.

In addition, a certification means issue module performs a preset user certification operation to issue a user certification confirmation means and a user mobile communication device executes an application program to perform a user certification procedure through the application program when a tag attached to the mobile robot is tagged. Then, a user certification server converts the mobile robot and the terminal module into an enable mode so as to allow a user to use the mobile robot and the terminal module after completion of the user certification procedure.

Accordingly, the mobile robot is converted into the enable mode upon reception of a certification code sent from the user certification server and shares the certification code with a terminal module previously paired therewith to convert the terminal module into the enable mode. The mobile robot converted into the enable mode is converted into the user tracking mode, the standby mode or the drive power assistance mode to assist in driving depending upon the location and distance of the user terminal module, and operates in an antitheft mode when a distance from the mobile robot to the user terminal module exceeds a preset antitheft reference in the course of assisting in driving.

In addition, when converted into the enable mode through reception of the certification code, the terminal module receives robot location data including location coordinates of the mobile robot previously paired therewith, compares location coordinates thereof with the location coordinates of the mobile robot to calculate the distance from the terminal module to the mobile robot in real time, and operates in the antitheft mode when the distance from the terminal module to the mobile robot exceeds a preset antitheft reference.

### Advantageous Effects

According to embodiments of the present disclosure, the mobile robot management service system can secure private data of a user requesting use of a mobile robot through a mobile communication device and the like and allows only a user obtaining use approval to use a user terminal module and the mobile robot, thereby preventing theft and loss of the mobile robot.

In addition, the mobile robot management service system assists in automatic charging of the user terminal module through a detachable holding structure of the user terminal module and the mobile robot, and allows the mobile robot to drive along a movement course of the user terminal module or assists in driving of the mobile robot, thereby further improving management convenience and user convenience.

Further, the mobile robot management service system allows a distance between a user carrying a user terminal module and a mobile robot to be automatically detected in real time and allows the terminal module and the mobile robot to operate simultaneously in an antitheft mode based on a detection result, thereby further improving efficiency in management of a plurality of terminal modules and mobile robots.

Further, the mobile robot allows not only a basket but also other loading boxes or luggage packaging members to be detachably mounted thereon while providing a function as a shopping cart, thereby further improving utilization of various types of mobile robots requiring a tracking type cart.

Further, the mobile robot may be driven in one mode selected from among a user tracking mode, a standby mode and a drive power support mode using an inexpensive sensor, such as a UWB (ultra-wide band) ToF sensor, a Lidar sensor, and the like, thereby reducing manufacturing costs of the mobile robot.

### DESCRIPTION OF DRAWINGS

FIG. 1 is a diagram of a mobile robot management service system according to embodiments of the present disclosure.

FIG. 2 is a block diagram of one user terminal module shown in FIG. 1.

FIG. 3 is a block diagram of a user certification server shown in FIG. 1.

FIG. 4 is a perspective view of a mobile robot capable of being used as a shopping cart shown in FIG. 1.

FIG. 5 is a block diagram of the mobile robot of FIG. 3.

FIG. 6 is a perspective view of the mobile robot of FIG. 3, with a basket module separated therefrom.

FIG. 7 is a block diagram of a second location detector shown in FIG. 4 to FIG. 6.

FIG. 8 is a block diagram of a drive assistance unit shown in FIG. 4 to FIG. 6.

FIG. 9 is a block diagram of a main controller shown in FIG. 4 to FIG. 6.

FIG. 10 is a diagram illustrating a user location data confirmation method of a location data confirmation unit shown in FIG. 9.

FIG. 11 is a diagram illustrating a method of detecting and confirming a distance between user terminal modules performed by the location data confirmation unit shown in FIG. 9.

### BEST MODE

The above and other aspects, features, and advantages of the present disclosure will be described in more detail in conjunction with the accompanying drawings so as to fully convey the spirit of the present disclosure to those skilled in the art. Descriptions of known functions and constructions which can unnecessarily obscure the subject matter of the present disclosure will be omitted. Hereinafter, embodiments of the present disclosure will be described in detail with reference to the accompanying drawings. Like components will be denoted by like reference numerals throughout the accompanying drawings.

Hereinafter, exemplary embodiments of the present disclosure will be described with reference to the accompanying drawings.

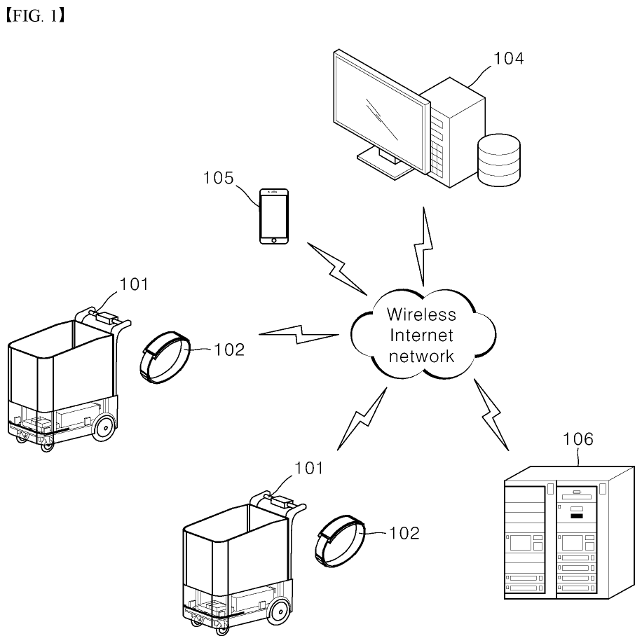

FIG. 1 is a diagram of a mobile robot management service system according to embodiments of the present disclosure.

According to the present disclosure, a mobile robot may be used not only as a shopping cart, but also as various types of mobile robots requiring tracking, such as logistics carts.

Referring to FIG. 1, the mobile robot management service system according to the embodiments of the present disclosure includes a user mobile communication device 105, at least one terminal module 102, at least one mobile robot 101 paired with at least one terminal module 102 and tracking the paired terminal module 102, a user certification server 104, and a certification means issue module 106.

Specifically, the user mobile communication device 105 may be a table mobile communication device, such as a smartphone, a tablet PC, and the like. When a tag attached to the mobile robot 101 is tagged on the mobile communication device 105 through a tag motion of a user, the mobile communication device 105 executes a preset application program through the tag. In addition, the mobile communication device 105 performs a login operation of the application program and sends login data and a certification request code of a user in response to a user certification request of preset manuals to perform a user certification procedure.

The user certification server 104 performs a preset certification operation including confirmation and storage of user private data corresponding to the login data upon reception of the login data and the certification request code through the application program of the user mobile communication device 105. Then, after completion of the preset certification operation, the user certification server 104 sends an approval code informing of certification completion and approval on use of the mobile robot 101 to the mobile robot 101, the tag of which is tagged. Then, upon reception of the approval code, the mobile robot 101 is converted into an enable mode and a standby mode while sharing the approval code with a terminal module 102 previously paired therewith to allow the terminal module 102 to be also converted into the enable mode.

The certification means issue module 106 may be constituted of an automatic certification terminal integrally formed with a touch monitor and the like, and acts as a user certification and approval request means which can be alternatively selected by a user in addition to a method for requesting approval on use of the mobile robot 101 through the application program of the mobile communication device 105.

With this configuration, the certification means issue module 106 sends the login data and the certification request code to the user certification server 104 to perform the user certification procedure upon request for approval on use of the mobile robot 101 through recognition of a user identification card or input of the user private data by the user. Then, the user certification server 104 performs a preset certification operation including confirmation and storage of the user private data sent from the certification means issue module 106. After completion of the preset certification operation, the user certification server 104 sends an approval code informing of certification completion and approval on use of the mobile robot 101 to the certification means issue module 106.

Upon reception of the approval code sent from the user certification server 104, the certification means issue module 106 issues a user certification confirmation means, such as a disposable card or a tag module, to the user. Then, the user converts the mobile robot 101 to be used thereby into an enable state by allowing the mobile robot 101 to recognize the disposable card or the tag module. That is, upon recognition of the user certification confirmation means, the mobile robot 101 is converted into an enable mode and a standby mode while sharing the approval code with the previously paired terminal module 102 to allow the terminal module 102 to be also converted into the enable mode.

The terminal module 102 may be stored in a state of being mounted on a device holder of the mobile robot 101. When the terminal module 102 is mounted on the device holder of the mobile robot 101, the terminal module 102 is converted into a disable state and a power turn-off state and is charged by the device holder of the mobile robot 101 and a battery.

Thereafter, the terminal module 102 is converted into the enable state upon reception of the approval code sent from the mobile robot 101. Then, when the terminal module 102 is detached from device holder of the mobile robot 101 by the user, the user terminal module 102 generates terminal location data including an identification code and location coordinates thereof in real time using a GPS communication module or a near-field communication module. Specifically, the user terminal module 102 may generate the location coordinates thereof in response to a GPS signal received through the GPS communication module, or through near-field wireless communication with a near-field wireless communication module, such as a plurality of beacons or Wi-Fi, near the user terminal module.

Then, the terminal module 102 receives robot location data including location coordinates of the mobile robot 101 paired therewith and monitors the distance from the user terminal module 102 to the mobile robot 101 corresponding to the received location coordinates in real time. Further, upon determination that the distance from the user terminal module 102 to the mobile robot 101 exceeds a preset antitheft reference, the terminal module 102 operates in an antitheft mode.

With the terminal module 102 mounted on the mobile robot 101, the mobile robot 101 is set to the standby mode and charges the terminal module. At least one tag is attached to the mobile robot 101. The tag includes at least one selected from among an NFC tag, a QR code, and a bar code. When a user tags a corresponding tag using the mobile communication device 105 to connect to the application program and performs the login operation, the user certification server 104 sends an approval code informing of certification completion and approval on use of the mobile robot 101 to the mobile robot 101.

Upon reception of the approval code, the mobile robot 101 is converted into the enable mode and the standby mode while sharing the approval code with the previously paired terminal module 102 to allow the terminal module 102 to be also converted into the enable mode.

In the enable mode, when the terminal module 102 is detached from the mobile robot 101, the mobile robot 101 senses the location, orientation and distance of the terminal module 102 in real time to operate in one mode selected from among a user tracking mode, a standby mode, and a drive power assistance mode.

Specifically, during operation in one mode selected from among the user tracking mode, the standby mode, and the drive power assistance mode, the mobile robot 101 detects the distance and orientation data with respect to the previously paired terminal module 102 and generate robot location data including an identification code and location coordinates thereof in real time.

As described above, in the course of operating in one mode selected from among the user tracking mode, the standby mode and the drive power support mode, the mobile robot 101 operates in an antitheft mode upon determination that the distance from the mobile robot 101 to the terminal module 102 exceeds a preset antitheft reference. Details and technical features of the terminal module 102 and the mobile robot 101 will be described below with reference to the accompanying drawings.

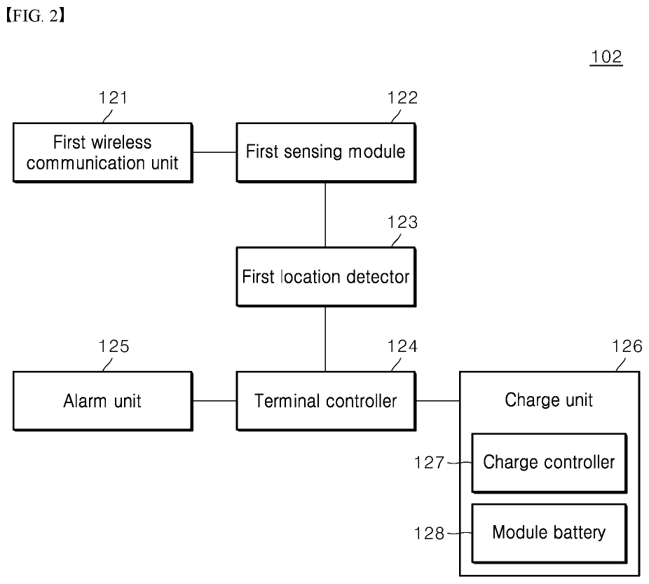

FIG. 2 is a block diagram of the user terminal module shown in FIG. 1.

Referring to FIG. 2, the user terminal module 102 includes a first wireless communication unit 121, a first sensing module 122, a first location detector 123, a terminal controller 124, an alarm unit 125, and a charge unit 126 including a charge controller 127 and a module battery 128.

Specifically, the first sensing module 122 generates the location coordinates thereof in response to a GPS signal received through the GPS communication module, or through near-field wireless communication with a near-field wireless communication module, such as a plurality of beacons or Wi-Fi, near the user terminal module 102.

The first location detector 123 generates terminal location data including a preset identification code and the location coordinates generated by the first sensing module 122. The first sensing module 122 and the first location detector 123 may include processor units, such as microcontrollers and the like.

The first wireless communication unit 121 is provided with a wireless communication module to perform wireless Internet communication with the mobile robot 101 to receive the approval code and the robot location data from the mobile robot 101.

The terminal controller 124 is a central processor unit and operates in the enable mode upon reception of the approval code and the robot location data from the mobile robot 101 through the first wireless communication unit 121. The terminal controller 124 calculates the distance from the terminal module to the mobile robot 101 in real time through comparison of the location coordinates included in the terminal location data with the location coordinates of the previously paired mobile robot 101. In addition, the terminal controller 124 operates in the antitheft mode and controls an alarm operation of the alarm unit 125 when the distance from the terminal module to the mobile robot 101 exceeds a preset antitheft reference.

The alarm unit 125 may include at least one alarm device selected from among an image display panel, a speaker and a lighting apparatus, and performs a theft and loss alarm operation through the at least one alarm device under control of the terminal controller 124. In the theft and loss alarm operation, a preset loss and departure guide message, an antitheft warning message, or the like is displayed in the form of sound, image and lighting through the at least one alarm device.

The charge unit 126 has an assembly structure to be detachably mounted on the device holder of the mobile robot 101. The charge controller 127 of the charge unit 126 supplies power to the module battery 128 upon receiving the power input through the device holder of the mobile robot 101 and controls a charge on/off operation of the module battery 128 depending upon a charged state of the module battery 128.

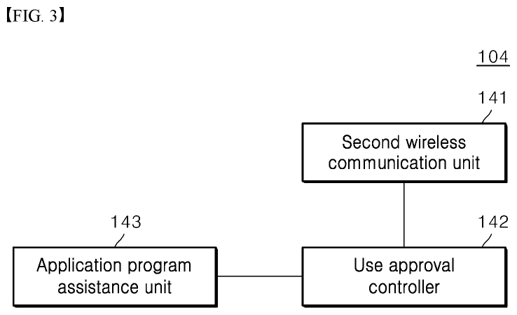

FIG. 3 is a block diagram of the user certification server shown in FIG. 1.

Referring to FIG. 3, the user certification server 104 includes an application program assistance unit 143, a second wireless communication unit 141, and a use approval controller 142.

Specifically, the second wireless communication unit 141 performs remote wireless communication, that is, wireless Internet communication, with the user mobile communication device 105, the mobile robot 101, and the certification means issue module 106. In addition, the second wireless communication unit 141 sends installation sources and execution files for the application program to the user mobile communication device 105.

In particular, upon reception of login data and a certification request code of a user sent from the user mobile communication device 105, the second wireless communication unit 141 sends the login data and the certification request code to the use approval controller 142. In addition, upon reception of an approval code informing of certification completion and approval on use of the mobile robot 101 sent from the use approval controller 142, the second wireless communication unit 141 sends the approval code to the mobile robot 101, the tag of which is tagged.

In addition, upon reception of the user private data and the certification request code sent from the certification means issue module 106, the second wireless communication unit 141 sends the user private data and the certification request code to the use approval controller 142. In addition, upon reception of the approval code informing of certification completion and approval on use of the mobile robot 101 sent from the use approval controller 142, the second wireless communication unit 141 sends the approval code to the corresponding certification means issue module 106.

The application program assistance unit 143 supplies the installation sources and execution files for the application program to the user mobile communication device 105 through the second wireless communication unit 141 to assist in installation of the application program in the user mobile communication device 105.

The application program assistance unit 143 may be associated with a separate service assistance server to support convenience improvement functions, such as reduction in user shopping time and the like by providing optimal shopping course guide data, discount data, automatic shopping cart list addition, payment scenario data, and the like.

Upon reception of the login data and the certification request code sent from the user mobile communication device 105 through the second wireless communication unit 141, the use approval controller 142 performs a preset certification operation including confirmation and storage of the user private data corresponding to the login data. Then, after completion of the preset certification operation, the use approval controller 142 sends an approval code informing of certification completion and approval on use of the mobile robot 101 to the mobile robot 101, the tag of which is tagged, through the second wireless communication unit 141.

Further, upon reception of the user private data and the certification request code sent from the certification means issue module 106 through the second wireless communication unit 141, the use approval controller 142 performs a preset certification operation including confirmation and storage of the user private data. Then, after completion of the preset certification operation, the use approval controller 142 sends the approval code informing of certification completion and approval on use of the mobile robot 101 to the certification means issue module 106 through the second wireless communication unit 141.

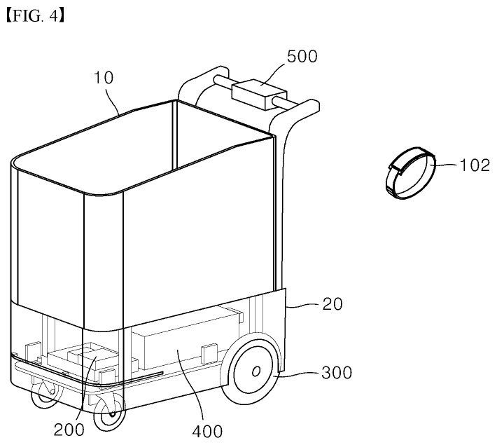

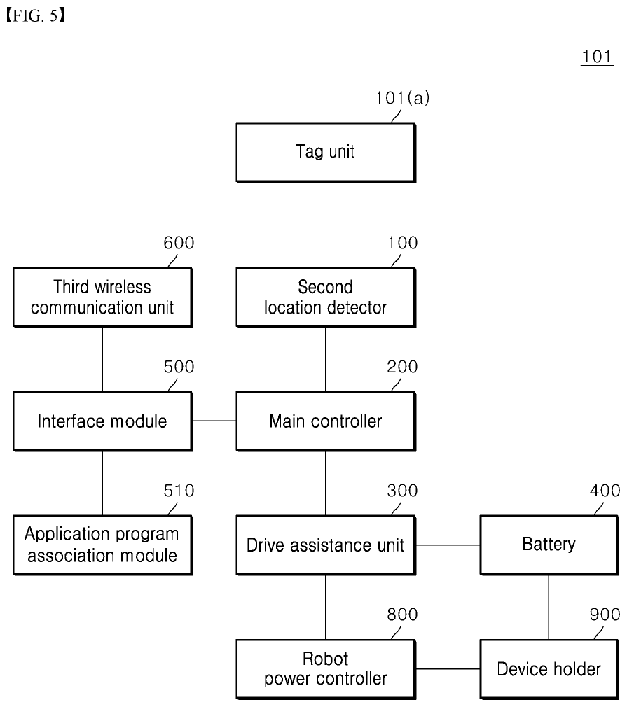

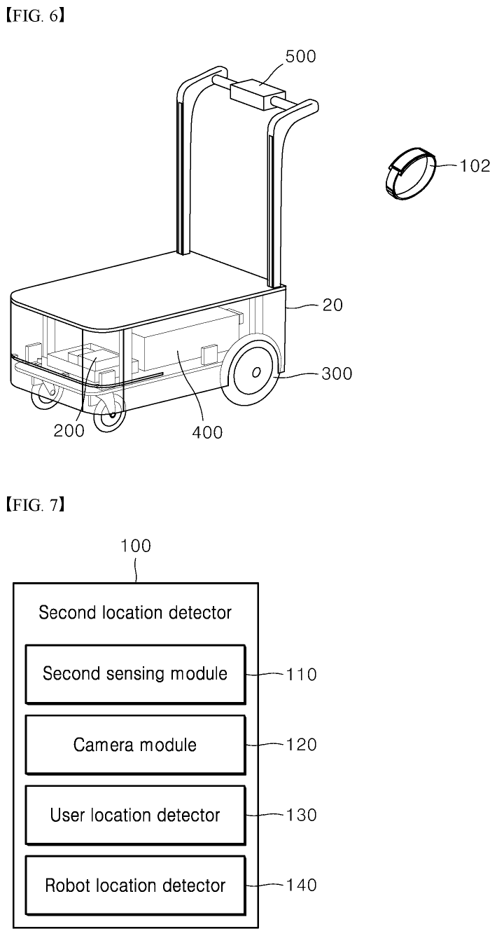

FIG. 4 is a perspective view of a mobile robot capable of being used as a shopping cart shown in FIG. 1. FIG. 5 is a block diagram of the mobile robot of FIG. 4. FIG. 6 is a perspective view of the mobile robot of FIG. 4, with a basket module separated therefrom.

Referring to FIG. 4 to FIG. 6, the mobile robot 101 includes a frame module 20 constituting a main body; a drive assistance unit 300 supplying power to a wheel of the frame module 20; a second location detector 100 detecting a location of the user terminal module 102; a third wireless communication unit 600 performing wireless communication; a main controller 200 assisting in driving of the mobile robot through setting and conversion of a drive mode while performing an antitheft control operation; a battery 400 supplying power to the drive assistance unit 300 and the like; a robot power controller 800; a device holder 900; and a tag unit 101(a) previously attached to peripheries of the device holder 900.

Together with inherent code data of the mobile robot 101, preset tags may be previous attached to the frame module 20 of the mobile robot 101, the device holder 900, or the peripheries of the device holder 900 to support execution of a preset application program. The tags of the tag 101(a) may be provided in the form of at least one of an NFC tag, a QR code, and a barcode.

The basket module 10 may be coupled to an upper portion or a front side of the frame module 20 and a hand frame is provided to a rear side of the frame module 20 to assist a user to control a drive direction of the mobile robot.

The hand frame of the frame module 20 may be further provided with a manual driving detector which is a component of the drive assistance unit 300. In addition, the hand frame may be provided with an interface unit 500, which displays a detection result of the location detector 100 detecting the location of the terminal module 102, drive mode setting and change of the main controller 200, a charged state of the battery 400, a drive state of the drive assistance unit 300, and the like.

The drive assistance unit 300 supplies power to at least one drive wheel motor of the frame module 20 to control drive force of the drive wheel motor. The drive assistance unit 300 supplies power to at least one drive wheel motor under control of the main controller 200 upon setting a user tracking mode of the main controller 200.

On the other hand, upon setting a user tracking drive power assistance mode of the main controller 200, the drive assistance unit 300 senses pushing force applied to the manual driving detector by a user. Then, the drive assistance unit 300 supplies power to at least one drive wheel motor of the frame module 20 so as to correspond to the sensed pushing force.

The second location detector 100 is mounted on the frame module 20 or the drive assistance unit 300 to detect the location and orientation of the terminal module 102, the distance from the mobile robot 101 to the user terminal module 102, and the like. Specifically, the location detector 100 may generate location coordinate data of the user terminal module 102 depending upon the distance and orientation data with respect to the user terminal module 102. The second location detector 100 sends detection results on the distance from the mobile robot 101 to the user terminal module 102 and the orientation of the user terminal module 102 to the main controller 200.

In addition, the second location detector 100 detects location coordinates thereof in response to a GPS signal received through a GPS communication module, and generates robot location data including an identification code and the location coordinates thereof. Then, the second location detector 100 sends the robot location data to the previously paired user terminal module 102 and a monitoring device 104 through the third wireless communication unit 600.

Upon reception of an approval code through the user certification server 104 or a temporary certification means, such as a temporary card and the like, the main controller 200 is converted into an enable mode and a standby mode while sharing the approval code with the previously paired terminal module 102 through the third wireless communication unit 600 to allow the terminal module 102 to be also converted into the enable mode.

After being converted into the enable mode and the standby mode, the main controller 200 may control the drive assistance unit 300 in the user tracking mode, the drive power assistance mode or the standby mode set by a user through the interface module 500.

Here, the main controller 200 may automatically control the drive assistance unit 300 by setting the user tracking mode according to the distance and orientation data with respect to the terminal module 102 detected by the second location detector 100, or may assist in manual driving of the drive assistance unit 300 by converting the drive mode into the drive power assistance mode depending upon whether the manual driving detector detects a user.

Specifically, the main controller 200 determines whether the terminal module 102 is placed in a preset neutral zone depending upon the distance and orientation data with respect to the user terminal module 102 detected by the second location detector 100. Upon determination that the user terminal module 102 is placed outside the preset neutral zone, the main controller 200 automatically controls the drive assistance unit 300 by setting the mobile robot 101 to operate in the user tracking mode.

In the user tracking mode, the main controller 200 compares the location coordinate data of the terminal module 102 sent from the location detector 100 with the coordinate data of the location detector 100. Then, the main controller 200 monitors the location coordinate data of the terminal module 102 in real time and generates movement course data of the terminal module 102 depending upon variation in location coordinates of the terminal module 102. Then, the main controller 200 sets drive coordinates and drive courses in real time through comparison of the movement course data of the user terminal module 102 with current location coordinate data of the location detector 100. Then, the main controller 200 controls the drive assistance unit 300 such that the mobile robot drives along the set drive coordinates and the drive course while maintaining a preset distance with respect to the terminal module 102.

Upon determination that the user terminal module 102 is placed in the neutral zone, the main controller 200 may convert the drive mode into the standby mode. In addition, when the manual driving detector senses user touch in the neutral zone, the main controller 200 converts the drive mode into the drive power assistance mode to assist in manual driving of the drive assistance unit 300. In the drive power assistance mode, the main controller 200 controls the drive assistance unit 300 to sense pushing force applied to the manual driving detector by a user and to assist in power supply to the drive wheel motor of the frame module 20.

In addition, the main controller 200 may automatically set or convert the drive mode into one mode selected from among the user tracking mode, the standby mode and the drive power assistance mode based on the orientation data with respect to the user terminal module 102 detected by the location detector 100. In other words, when the user terminal module 102 is moved outside the neutral zone in a front direction of the location detector 100, the main controller 200 may convert the drive mode into the user tracking mode and automatically control the drive assistance unit 300. Conversely, when the user terminal module 102 is detected in a lateral direction of the location detector 100, the main controller 200 may set or convert the drive mode into the standby mode. In addition, when the user terminal module 102 is moved into the neutral zone in a rear direction of the location detector 100, the main controller may set or convert the drive mode into the drive power assistance mode to assist in manual driving of the drive assistance unit 300.

In the course of assisting in driving in one mode selected from among the user tracking mode, the standby mode, and the drive power assistance mode, the main controller 200 compares the distance data with respect to the user terminal module 102 detected by the second location detector 100 with a preset antitheft reference in real time, and operates in the antitheft mode to control an alarm operation of the interface module 500 upon determination that the distance between the mobile robot and the user terminal module 102 exceeds the preset antitheft reference.

The interface module 500 includes at least one alarm device selected from among an image display panel, a speaker and a lighting apparatus, and performs a theft and loss alarm operation through the at least one alarm device under control of the terminal controller 124. Upon operation in the antitheft mode, a preset loss and departure guide message, an antitheft warning message, or the like is displayed in the form of sound, image and lighting through the at least one alarm device.

The battery 400 supplies drive power to the drive assistance unit 300, the second location detector 100, and the main controller 200 in real time.

Upon operation of the main controller 200 in the antitheft mode, the robot power controller 800 blocks power supply from the battery 400 to the drive assistance unit 300 under control of the main controller 200.

Specifically, upon operation in the antitheft mode, the main controller 200 sends a control signal for blocking power of the drive assistance unit 300 to the power controller 800. Then, the power controller 800 controls a current breaker therein according to the power blocking control signal to block power supply from the battery 400 to the drive assistance unit 300. When power supply to the drive assistance unit 300 is blocked, the drive wheel motor of the drive assistance unit 300 is stopped and is set to maintain an automatic break state, whereby driving and movement of the mobile robot 101 can be restricted.

The device holder 900 has an assembly structure and supplies power of the battery 400 to the terminal module 102 mounted thereon to assist in charging of the terminal module 102.

FIG. 7 is a block diagram of the second location detector shown in FIG. 4 to FIG. 6.

Referring to FIG. 7, the second location detector 100 includes a second sensing module 110, a camera module 120, a user location detector 130, and a robot location detector 140.

Specifically, the second sensing module 110 detects distance and orientation data with respect to the user terminal module 102 through recognition of the user terminal module 102. To this end, the second sensing module 110 may include at least one UWB (ultra-wide band) sensor (for example, a ToF sensor and Lidar), a microcontroller adapted to convert a sensing signal into a digital signal and to generate orientation data, a wired/wireless communication module, and the like.

The camera module 120 photographs the user terminal module 102 to detect the orientation data with respect to the terminal module 102. The camera module 120 photographs the terminal module 102 using an image sensor, such as a charge-coupled device (CCD), to detect the orientation data of the terminal module 102 based on results of comparison of locations and orientations of the terminal module 102 and the camera module 120.

The user location detector 130 receives the distance and orientation data with respect to the user terminal module 102 and generates location coordinate data of the user terminal module 102. Further, the user location detector 130 generates location coordinate comparison data of the user terminal module 102 with reference to reference coordinates of the location detector 100 by comparing reference coordinate data of the location detector 100 supplied from the robot location detector 140 with the location coordinate data of the user terminal module 102. Here, the robot location detector 140 detects a current location thereof and generates location coordinate data thereof as reference coordinate data based on the detection results of the distance and orientation with respect to the user terminal module 102.

Further, the robot location detector 140 detects the location coordinates thereof in response to a GPS signal received through a GPS communication module and generates robot location data including an identification code and the location coordinates thereof. The robot location data is sent to the previously paired user terminal module 102 through the third wireless communication unit 600.

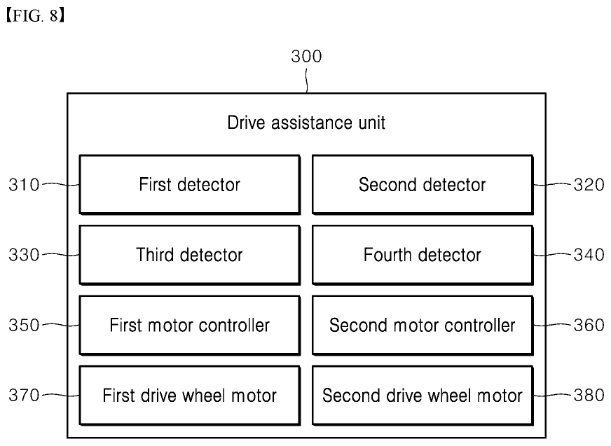

FIG. 8 is a block diagram of a drive assistance unit shown in FIG. 4 to FIG. 6.

Referring to FIG. 8, the drive assistance unit 300 includes a plurality of manual driving detectors 310 to 340, first and second drive wheel motors 370, 380, and first and second motor controllers 350, 360.

The manual driving detectors 310 to 340 detect user touch and pushing force applied thereto, and generate front/rear detection signals corresponding to the detected pushing force. For example, a right-side hand frame is provided with first and second detectors 310, 320 in front and rear directions thereof to be used as user grippers. Here, the first detector 310 detects rearward pushing force applied by a user and the second detector 320 detects forward pushing force applied by the user.

A left-side hand frame is provided with third and fourth detectors 330, 340 in the front and rear directions thereof to be used as user grippers. The third detector 330 and the fourth detector 340 detect rearward and forward pushing force applied by a user, respectively. With the gripper-shaped configuration, the first to fourth detectors 310 to 340 detect the forward/rearward user touch and pushing force applied by the user, and generate the front/rear detection signals corresponding to the detected pushing force.

Each of the first and second drive wheel motors 370, 380 includes at least one electric motor and a power transmission shaft to supply drive force to each of wheel shafts of the frame module 20.

When the main controller 200 sets the drive power assistance mode, the first and second motor controllers 350, 360 may control the drive force of each of the first and second drive wheel motors 370, 380 so as to correspond to the forward/rearward user touch and pushing force detected by the first to fourth detectors 310 to 340.

In addition, when the main controller 200 sets the user tracking mode, the first and second motor controllers 350, 360 may control the drive force of each of the first and second drive wheel motors 370, 380 in response to a control signal from the main controller 200.

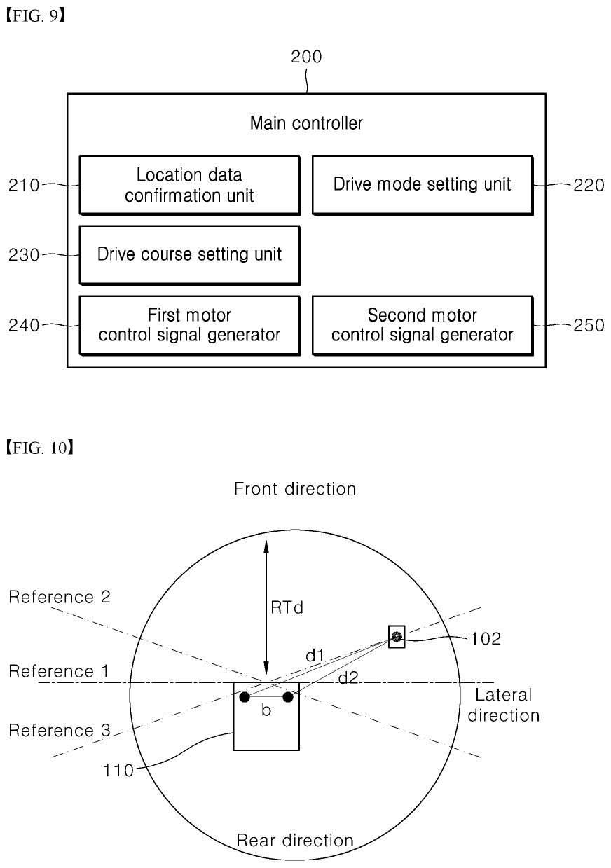

FIG. 9 is a block diagram of the main controller shown in FIG. 4 to FIG. 6.

Referring to FIG. 9, the main controller 200 may include at least one selected from among a location data confirmation unit 210, a drive mode setting unit 220, a drive course setting unit 230, and a plurality of motor control signal generators 240, 250. With these components, the main controller 200 may control the drive assistance unit 300 corresponding to the user tracking mode or the drive power assistance mode set by a user and displayed on the interface module 500.

Specifically, the location data confirmation unit 210 of the main controller 200 receives the location coordinate data of the user terminal module 102 and the coordinate data of the location detector 100 through the location detector 100 in real time. Then, the location data confirmation unit 210 generates the movement course data of the user terminal module 102 through comparison of the location coordinate data of the user terminal module 102 with the coordinate data of the location detector 100.

Upon reception of the approval code through the user certification server 104 or the temporary certification means, such as a temporary card and the like, the drive mode setting unit 220 is converted into the enable mode and the standby mode while sharing the approval code with the previously paired terminal module 102 through the third wireless communication unit 600 to allow the terminal module 102 to be also converted into the enable mode.

Then, based on a comparison result between the location coordinate data of the user terminal module 102 and the coordinate data of the location detector 100, the drive mode setting unit 220 may automatically set or convert the drive mode into one mode selected from among the user tracking mode, the standby mode, and the drive power assistance mode. In addition, the drive mode setting unit 220 sends a mode conversion signal to the drive assistance unit 300.

Furthermore, in the course of assisting in driving in one mode selected from among the user tracking mode, the standby mode, and the drive power assistance mode, the drive mode setting unit 220 compares the distance data with respect to the user terminal module 102 with a preset antitheft reference in real time. Further, upon determination that the distance from the mobile robot to the user terminal module 102 exceeds the preset antitheft reference, the drive mode setting unit 220 sets the antitheft mode and controls the alarm operation of the interface module 500 corresponding thereto. Technical features of the drive mode setting unit 220 in mode setting and conversion will be described in more detail with reference to the accompanying drawings.

When the user tracking mode is set by the drive mode setting unit 220, the drive course setting unit 230 compares the movement course data of the terminal module 102 with current location coordinate data of the location detector 100. Then, the drive course setting unit 230 sets drive coordinates and a drive course in real time based on a comparison result.

The plurality of motor control signal generators 240, 250 includes first and second motor control signal generators 240, 250. Each of the first and second motor control signal generators 240, 250 controls first and second motor controllers 350, 360 of the drive assistance unit 300 such that the mobile robot drives along the drive coordinates and the drive course set by the drive course setting unit 230 while maintaining a preset distance with respect to the user terminal module 102.

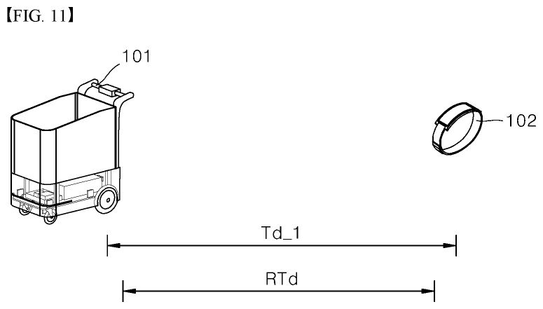

FIG. 10 is a diagram illustrating a user location data confirmation method of the location data confirmation unit shown in FIG. 9. In addition, FIG. 11 is a diagram illustrating a method of detecting and confirming a distance between user terminal modules performed by the location data confirmation unit shown in FIG. 9.

Referring to FIG. 10 and FIG. 11, the drive mode setting unit 220 of the main controller 200 determines, based on the comparison result between the location coordinate data of the user terminal module 102 and the coordinate data of the location detector 100, whether the user terminal module 102 is placed in or outside a preset neutral zone RTd and is farther apart from an antitheft reference Td_1. Upon determination that the user terminal module 102 is placed within the antitheft reference Td_1 outside the neutral zone RTd, the drive mode setting unit 220 converts the current drive mode into the user tracking mode and automatically controls the drive assistance unit 300.

Further, upon determination that the user terminal module 102 is placed in the neutral zone RTd, the drive mode setting unit 220 of the main controller 200 converts the current drive mode into the standby mode. Then, when the manual driving detector detects user touch within the neutral zone RTd, the drive mode setting unit 220 may convert the current drive mode into the drive power assistance mode to allow the drive assistance unit 300 to assist in manual driving.

Furthermore, in the drive power assistance mode, the main controller 200 may control the drive assistance unit 300 to supply power to the drive wheel motor of the frame module 20 based on detection of the pushing force applied to the manual driving detectors by a user.

The drive mode setting unit 220 of the main controller 200 determines whether the user terminal module 102 is placed in any one range among a plurality of preset reference ranges (References 1 to 3), based on the comparison result between the location coordinate data of the user terminal module 102 and the coordinate data of the location detector 100. In addition, based on the confirmation result, the location detector 100 detects the current location data of the user terminal module 102 by determining that the terminal module 102 is placed in the front direction, the lateral direction, or the rear direction.

Upon determination that the terminal module 102 is moved outside the neutral zone in the front direction of the location detector 100, the drive mode setting unit 220 may convert the drive mode into the user tracking mode to automatically control the drive assistance unit 300.

On the other hand, upon determination that the terminal module 102 is detected in the neutral zone in the lateral direction of the location detector 100, the drive mode setting unit 220 may convert the drive mode into the standby mode. In addition, upon determination that the terminal module 102 is moved into the neutral zone in the rear direction of the location detector 100, the drive mode setting unit 220 may convert the drive mode into the drive power assistance mode to allow the drive assistance unit 300 to assist in manual driving.

On the other hand, upon determination that the terminal module 102 is farther apart from the antitheft reference Td_1, the drive mode setting unit 220 of the main controller 200 converts the drive mode into the antitheft mode to control the alarm operation of the interface module 500. Furthermore, the drive mode setting unit 220 sends the control signal for blocking power of the drive assistance unit 300 to the power controller 800.

According to the embodiments described above, the mobile robot management service system can secure private data of a user requesting use of the mobile robot 101 through the mobile communication device 105 and the like and allows only a user obtaining use approval to use the terminal module 102 and the mobile robot 101.

In addition, the mobile robot management service system assists in automatic charging of the terminal module 102 through the detachable holding structure of the terminal module 102 and the mobile robot 101, and allows the mobile robot 101 to drive along a movement course of the terminal module 102 or assists in driving of the mobile robot 101, thereby further improving management convenience of a manager and use convenience of a user.

Further, the mobile robot management service system can automatically detect the distance between a user carrying the terminal module 102 and the mobile robot 101 in real time to allow the terminal module 102 and the mobile robot 101 to operate simultaneously in an antitheft mode, further improving efficiency in management of a plurality of terminal modules and mobile robots.

Although some embodiments have been described herein with reference to the accompanying drawings, it should be understood that these embodiments are provided for illustration only and are not to be construed in any way as limiting the present disclosure, and that various modifications, changes, alterations, and equivalent embodiments can be made by those skilled in the art without departing from the spirit and scope of the present disclosure.

1-15. (canceled)

16. A mobile robot management service system comprising:
a terminal device configured to generate location data comprising location coordinates of the terminal device; and
a mobile robot configured to:
enter a standby mode and charge the terminal device when the terminal device is mounted on the mobile robot, and
in response to the terminal device being detached from the mobile robot, enter a mode selected from among a user tracking mode, the standby mode and a drive power assistance mode, and detect a location of the terminal device and a distance between the mobile robot and the terminal device in real time.

17. The mobile robot management service system according to claim 16, wherein:
the terminal device comprises a charging assembly structure configured to be detachably mounted on a device holder of the mobile robot, and
the charging assembly structure is configured to supply power to a battery in the terminal device upon receiving the power input through the device holder of the mobile robot, and control a charge on/off operation of the battery based on a charged state of the battery.

18. The mobile robot management service system according to claim 16, wherein the mobile robot comprises a device holder having an assembly structure configured to allow the terminal device to be detachably mounted on the device holder, and assist in charging of the terminal device by supplying power from a battery in the mobile robot to the terminal device when the terminal device is mounted on the device holder.

19. A mobile robot management service system comprising:
a terminal device configured to generate terminal location data comprising location coordinates of the terminal device;
a mobile robot configured to:
charge the terminal device when the terminal device is mounted on the mobile robot, and
in response to entering an enable state, enter a mode selected from among a user tracking mode, a standby mode and a drive power assistance mode;
a user mobile communication device configured to execute an application program for performing a user certification procedure through the application program when a tag attached to the mobile robot is tagged; and
a user certification server configured to set the mobile robot and the terminal device to the enable state to allow a user to use the mobile robot and the terminal device after completion of the user certification procedure.

20. The mobile robot management service system according to claim 19, wherein the user certification server comprises:
a second wireless communication unit configured to perform wireless communication with the user mobile communication device and the mobile robot;
an application program assistance unit configured to supply an execution file for installing the application program in the user mobile communication device; and
a use approval controller configured to perform a preset certification operation in response to receiving login data and a certification request code of the user from the user mobile communication device via the second wireless communication unit, and transmit an approval code indicating certification completion and approval for use of the mobile robot to the mobile robot.

21. The mobile robot management service system according to claim 20, wherein the second wireless communication unit is further configured to:
transmit the login data and the certification request code to the use approval controller in response to receiving the login data and the certification request code from the user mobile communication device, and
transmit the approval code to the mobile robot in response to receiving the approval code from the use approval controller.

22. The mobile robot management service system according to claim 20, wherein the preset certification operation includes confirming of user private data corresponding to the login data and the certification request code, and transmitting the approval code through the second wireless communication unit.

23. The mobile robot management service system according to claim 20, wherein the user mobile communication device is further configured to execute the application program based tagging of the tag, perform a login operation of the application program, and transmit the login data and the certification request code to the user certification server.

24. The mobile robot management service system according to claim 23, wherein the mobile robot enters the enable state based on sharing the approval code with the terminal device to allow the terminal device to also enter the enable state upon reception of the approval code from the user certification server, and the mobile robot is set to the user tracking mode, the standby mode or the drive power assistance mode based on a location of the terminal device and a distance between the mobile robot and the terminal device while in the enable state.

25. The mobile robot management service system according to claim 24, wherein the terminal device is further configured to:
receive robot location data comprising location coordinates of the mobile robot,
compare the location coordinates of the mobile robot with the location coordinates of the terminal device to calculate the distance between the mobile robot and the terminal device, and
operate in an antitheft mode when the distance between the mobile robot and the terminal device exceeds a preset antitheft reference distance.

26. A mobile robot management service system comprising:
a certification issuer configured to perform a preset user certification operation for issuing user certification confirmation information to a user;
a mobile robot configured to:
charge a terminal device when the terminal device is mounted on the mobile robot, and
in response to the user certification confirmation information being recognized based on a tagging operation, enter an enable state and a mode selected from among a user tracking mode, a standby mode, and a drive power assistance mode;
a user mobile communication device configured to execute an application program to perform a user certification procedure through the application program when a tag attached to the mobile robot is tagged based on the tagging operation; and
a user certification server configured to set the mobile robot and the terminal device in the enable state to allow the user to use the mobile robot and the terminal device after completion of the user certification procedure.

27. The mobile robot management service system according to claim 26, wherein the user certification server comprises:
a second wireless communication unit configured to perform wireless communication with the user mobile communication device, the mobile robot, and the certification issuer;
an application program assistance unit configured to supply an execution file for installing the application program in the user mobile communication device; and
a use approval controller configured to perform a preset certification operation in response to receiving login data or user private data and a certification request code of the user from the certification issuer, and transmit an approval code indicating certification completion and approval for use of the mobile robot to the certification issuer.

28. The mobile robot management service system according to claim 27, wherein the second wireless communication unit is further configured to:
transmit the login data or the user private data and the certification request code to the use approval controller in response to receiving the login data or the user private data and the certification request code from the certification issuer, and
transmit the approval code to the certification issuer in response to receiving the approval code from the use approval controller.

29. The mobile robot management service system according to claim 27, wherein the preset certification operation includes confirming the user private data and the certification request code, and transmitting the approval code to the certification issuer through the second wireless communication unit.

30. The mobile robot management service system according to claim 28, wherein the mobile robot comprises a device holder having an assembly structure configured to allow the terminal device to be detachably mounted on the device holder, and assist in charging of the terminal device by supplying power from a battery in the mobile robot to the terminal device when the terminal device is mounted on the device holder.

31. The mobile robot management service system according to claim 30, wherein the mobile robot enters the enable state based on sharing the approval code with the terminal device to allow the terminal device to also enter the enable state upon reception of the approval code from the certification issuer, and
the mobile robot is set to the user tracking mode, the standby mode or the drive power assistance mode based on a location of the terminal device and a distance between the mobile robot and the terminal device while in the enable state.

32. The mobile robot management service system according to claim 31, wherein the mobile robot operates in an antitheft mode when the distance between the mobile robot and the terminal device exceeds a preset antitheft reference distance.

33. A mobile robot comprising:
a frame constituting a main body of the mobile robot;
a drive assistance unit configured to supply power to a drive wheel of the frame; and
a controller configured to:
receive location data from a terminal device, enter a standby mode and charge the terminal device when the terminal device is mounted on the mobile robot, and
in response to the terminal device being detached from the mobile robot, enter a mode selected from among a user tracking mode, the standby mode and a drive power assistance mode, and detect a location of the terminal device and a distance between the mobile robot and the terminal device in real time.

34. The mobile robot according to claim 33, further comprising:
a device holder having an assembly structure configured to allow the terminal device to be detachably mounted on the device holder, and assist in charging of the terminal device by supplying power from a battery in the mobile robot to the terminal device when the terminal device is mounted on the device holder.

35. The mobile robot according to claim 33, further comprising:
a tag for performing a user certification procedure through an application program for allowing use of the mobile robot by a user when the tag is tagged.
